(19) United States
(12) Patent Application Publication
(10) Pub. No.: US 2019/0097204 A1
(43) Pub. Date: Mar. 28, 2019

(54) Lithium Ion Battery With Modular Bus Bar Assemblies

(71) Applicant: Cadenza Innovation, Inc., Wilton, CT (US)

(72) Inventors: Joshua Liposky, Seymour, CT (US); Maria Christina Lampe-Onnerud, Wilton, CT (US); Tord Per Jens Onnerud, Wilton, CT (US); Jay Shi, Acton, MA (US)

(73) Assignee: Cadenza Innovation, Inc., Wilton, CT (US)

(21) Appl. No.: 16/050,195

(22) Filed: Jul. 31, 2018

Related U.S. Application Data
(60) Provisional application No. 62/561,927, filed on Sep. 22, 2017.

(51) Int. Cl. H01M 2/20; H01M 10/0525; H01M 2/10; H01M 2/02; H01M 2/04; H01M 2/34; H01M 2/12; H01M 10/653

(52) U.S. Cl. CPC H01M 2/206; H01M 10/0525; H01M 2/1077; H01M 2/0237; H01M 2/043; H01M 2200/103; H01M 2/127; H01M 10/653; H01M 2/1094; H01M 2200/20; H01M 2/345

(57) ABSTRACT

Lithium ion batteries are provided that include a plurality of electrochemical units positioned within a container or assembly. A multi-layered bus bar is provided to establish electrical connection with the anode and cathode of the electrochemical units. Based on the design of the bus bar, a desired voltage and capacity may be delivered by the battery without redesign or redeployment of the electrochemical units within the container or assembly. A plurality of bus bars may be interchangeably introduced to the container/assembly to yield lithium ion batteries that deliver differing voltage and/or capacity.

### CROSS-REFERENCE TO RELATED APPLICATIONS

The present application claims priority benefit to a provisional patent application entitled “Lithium Ion Battery with Modular Bus Bar Assemblies,” which was filed on Sep. 22, 2017, and assigned Ser. No. 62/561,927. The content of the foregoing provisional application is incorporated herein by reference.

### GOVERNMENT RIGHTS

This invention was made with government support under DE-AR0000392 awarded by the United States Department of Energy. The government has certain rights in the invention.

The present application also hereby incorporates by reference the following patent filings in their entireties: (i) U.S. Pat. No. 9,685,644 entitled “Lithium Ion Battery,” (ii) U.S. Patent Publication No. 2017/0214103 entitled “Lithium Ion Battery with Thermal Runaway Protection,” and (iii) PCT Publication No. WO 2017/106349 entitled “Low Profile Pressure Disconnect Device for Lithium Ion Batteries.”

### FIELD OF DISCLOSURE

The present disclosure relates to lithium ion batteries and, more particularly, to multi-core lithium ion batteries having improved safety and reduced manufacturing costs. More particularly, the present disclosure relates to lithium ion batteries that are designed to accommodate varying bus bar assemblies to provide serial and parallel jelly roll configurations, thereby delivering increased voltage or higher capacity without modification to the underlying battery design and layout.

### BACKGROUND

Li-ion cells were initially deployed as batteries for laptops, cell phones and other portable electronics devices. An increase in larger applications, such as battery electric vehicles (BEV), Plug-in Hybrid Electric Vehicles (PHEV), and Hybrid Electric Vehicles (HEV), electric trains, as well as other larger format systems, such as grid storage (GRID), construction, mining and forestry equipment, forklifts, other driven applications and lead acid replacement (LAR), are entering the market due to the need for lowering of emissions and lowering of gasoline and electricity costs, as well as limiting emissions. A wide variety of Li-ion cells are deployed today in these larger battery applications ranging from use of several thousand of smaller cylindrical and prismatic cells, such as 18650 and 183765 cells, ranging in capacity from 1 Ah to 7 Ah, as well as a few to a few hundred larger cells, such as prismatic or polymer cells having capacities ranging from 15 Ah to 100 Ah. These type of cells are produced by companies such as Panasonic, Sony, Sanyo, ATL, JCI, Boston-Power, SDI, LG Chemical, SK, BAK, BYD, Lishen, Coslight and other Li-ion cell manufacturers.

In general, the industry needs to drive to higher energy density in order to achieve longer run time, which for electrified vehicles leads to increased electric range and for grid storage systems translates to longer and more cost effective deployment. In the case of electrified vehicles, and in particular BEVs and PHEVs, an increased energy density leads to an ability to increase driving range of the vehicle, as more capacity can fit into the battery box. The higher energy density also leads to an ability to lower cost per kWh, as the non-active materials, such as the battery box, wiring, BMS electronics, fastening structures, cooling systems, and other components become less costly per kWh. Similarly, for other battery systems, such as grid storage, there is a market need for higher energy density in particular for peak shaving applications (i.e., applications that support reductions in the amount of energy purchased from utilities during peak hours when the charges are highest). Also, cost per kWh is less for high energy density as relatively less real estate and inactive components per kWh can be used. In addition, for highly populated areas, such as the metropolitan areas of New York, Tokyo, Shanghai and Beijing, the sizes of systems need to be minimized. There is a need to fit the battery systems into commercial and residential buildings and containers to contribute to grid peak power reduction strategies, leading to lower electricity cost and reduction of peaker plants (i.e., power plants that run only when there is a high demand for electricity) that operate with low efficiency.

Li-ion batteries serving these type of needs must become less costly and of higher energy density to be competitive in the market place when compared to other battery and power delivering technologies. However, as Li-ion cells are packaged more densely, there is a risk that a failure of one cell from abuse may lead to propagating (cascading) runaway in the entire system, with a risk of explosion and fire. This abuse can come from external events, such as crash and fire, and also from internal events, such as inadvertent overcharge due to charging electronics failures or internal shorts due to metal particulates from the manufacturing process.

There is a need to find new solutions where abuse failures do not lead to cascading runaway, and to thereby enable systems of higher energy density and lower cost. A cell having reliable non-cascading attributes will enable lower battery pack costs, at least in part based on a reduction in costly packaging structures.

There is also a need to improve manufacturing efficiencies and costs in the lithium ion battery field. For example, certain industrial applications require increased voltage to meet product requirements, whereas other industrial applications require higher energy capacities. While the underlying lithium ion components may be similar in design for high voltage/high capacity applications, the ability to arrange cells in series, in whole or in part (for higher voltage), or in parallel, in whole or in part (for higher energy capacity), generally require distinct battery designs that entail manufacturing/inventory costs and inefficiencies to separately implement.

The present disclosure provides advantageous designs that address the needs and shortcomings outlined above. Additional features, functions and benefits of the disclosed battery systems will be apparent from the description which follows, particularly when read in conjunction with the appended figure(s), examples and experimental data.

### SUMMARY

Advantageous casings for lithium ion batteries are provided that include, inter alia, (i) a container or assembly that defines a base, side walls and a top or lid for receiving electrochemical units, (ii) a plurality of electrochemical units positioned within the container or assembly, and (iii) a bus bar positioned within the container or assembly and in electrical communication with the anode and cathode of each electrochemical unit. In exemplary embodiments, the electrochemical units are “unsealed”, i.e., in communication with a shared atmosphere. In alternative embodiments, the electrochemical units may be individually sealed, or may include an element or region that provides a sealing function that is released if conditions within the electrochemical unit require venting and/or release of heat into a shared atmosphere.

The bus bar assemblies of the present disclosure generally define a laminated structure that includes first and second conductive structures that are separated by a non-conductive element (or coating). The bus bar advantageously functions to interconnect the anodes of the electrochemical units to a negative terminal member external to the enclosure, and to interconnect the cathodes of the electrochemical units to a positive terminal member external to the enclosure.

The conductive aspects of the bus bar may be fabricated from various conductive materials, e.g., metallic materials, conductive polymeric materials, and combinations thereof. The most common conductive bus bar materials are aluminum, copper and nickel. Indeed, the conductive aspects of the disclosed bus bars are advantageously fabricated from aluminum and copper due to the high electric conductivity and low cost associated with such metallic materials. The insulation material positioned between conductive layers is generally selected from known non-conductive/insulative materials, e.g., non-conductive polymers, ceramics and combinations thereof. Exemplary insulation materials include polyethylene, polypropylene and polytetrafluoroethylene (e.g., Teflon™ material).

The bus bar assemblies are engineered so as to place a desired number of electrochemical units in a parallel configuration and a desired number of electrochemical units in a serial configuration. For example, for a lithium ion battery that contains thirty (30) electrochemical units, the bus bar assembly may be effective to define a 10S-3P configuration, i.e., 10 cells in series, 3 in parallel. A second bus bar assembly may be effective to define a 1S-30P configuration for the same electrochemical unit deployment within the container or assembly. Thus, by providing a multiplicity of bus bar assembly designs, it is advantageously possible to provide a multiplicity of voltage/capacity options with a lithium battery design/layout that is otherwise unchanged. A manufacturing decision as to the voltage/capacity may thus be made after assembly of the lithium ion battery up to the point of introducing the bus bar to the container/assembly. A multiplicity of bus bar designs may be maintained in inventory and may be utilized, as desired, to provide lithium ion batteries with desired voltage/capacity properties.

The disclosed lithium ion battery may also include a pressure disconnect device associated with the container or assembly. The disclosed pressure disconnect device advantageously electrically isolates electrochemical units associated with the lithium ion battery in response to a build up of pressure within the container that exceeds a predetermined pressure threshold. The disclosed container may also advantageously include a vent structure that functions to release pressure from within the container, and a flame arrestor positioned in proximity to the vent structure.

In exemplary embodiments of the present disclosure, a casing for a lithium ion battery is provided that includes, inter alia, (i) a container/assembly that defines a base, side walls and a top or lid, (ii) a deflectable dome structure associated with the container/assembly, and (iii) a fuse assembly positioned external to the container/assembly that is adapted, in response to a pressure build-up within the container/assembly beyond a threshold pressure level, to electrically isolate lithium ion battery components positioned within the container. The fuse assembly may include a fuse that is positioned within a fuse holder positioned external to the container. The fuse holder may be mounted with respect to a side wall of the container/assembly. The disclosed casing may further include a vent structure formed adjacent to the fuse assembly with respect to the side wall of the container and/or a flame arrestor positioned adjacent the vent structure.

In exemplary embodiments of the present disclosure, the deflectable dome is mounted directly to the casing. More particularly, the deflectable dome is mounted internal of an opening formed in the casing (either the base, side wall or top/lid thereof) and is initially bowed into the internal volume defined by the casing relative to the casing face to which it is mounted. The fuse assembly that is mounted with respect to an external face of the casing advantageously includes a hammer or other structural feature that is aligned with the center line of the deflectable dome to facilitate electrical communication therebetween when the deflectable dome is actuated by a pressure build up within the casing.

The deflectable dome may advantageously include a thickness profile whereby the deflectable dome defines a greater thickness at and around the centerline of the dome, and a lesser thickness radially outward thereof. The greater thickness at and around the centerline of the dome provides a preferred electrical communication path between the deflectable dome and the disclosed hammer or other structural feature, i.e., when the deflectable dome is actuated by an increased pressure within the casing. The lesser thickness that exists radially outward of the thicker region defined by the deflectable dome reduces the likelihood of arcing from such reduced thickness regions to the hammer or other structural feature. The dome should further be triggered at as low pressure as possible and preferably move quickly once activated to provide highest safety. Of further note, the greater thickness at and around the centerline of the deflectable dome advantageously reduces the likelihood of burn through as the current passes between the deflectable dome and the hammer or other structural feature associated with the fuse assembly.

In exemplary embodiments of the present disclosure, the multiple lithium ion cores (i.e., electrochemical units) are positioned in distinct cavities defined by a support member, but are not individually sealed. Rather, each of the electrochemical units is open and in communication with a shared atmosphere region defined within the case/container. As a result, any pressure build up that might be associated with a single electrochemical unit is translated to the shared atmosphere region and the increase in pressure is thereby mitigated. In such way, a pressure disconnect device of the present disclosure—which is advantageously in pressure communication with the shared atmosphere region—may, due to its larger size compared to being mounted on an individual electrochemical unit, be operational at a lower threshold pressure as compared to conventional lithium ion battery systems that do not include a shared atmosphere region.

The pressure at which the pressure disconnect device of the present disclosure is activated is generally dependent on the overall design of the lithium ion battery. However, the threshold pressure within the casing which activates the disclosed pressure disconnect device is generally 10 psig or greater, and is generally in the range of 10-40 psig. In embodiments that also include a vent structure, the pressure at which the vent structure is activated to vent, i.e., release pressurized gas from the casing, is generally at least 5 psig greater than the pressure at which the pressure disconnect device is activated. The overall pressure rating of the casing itself, i.e., the pressure at which the casing may fail, is generally set at a pressure of at least 5 psig greater than the pressure at which the vent structure is activated. The pressure rating of the casing has particular importance with respect to interface welds and other joints/openings that include sealing mechanisms where failures are more likely to occur.

In exemplary pressure disconnect devices of the present disclosure, the hammer or other structural element is mounted with respect to the fuse assembly in a mounting plane, and includes a portion that advantageously extends toward the deflectable dome relative to the mounting plane. In this way, the travel distance required for the deflectable dome is reduced when it is desired that the pressure disconnect device be activated. The hammer or other structural element is generally fixedly mounted relative to a mounting plane of the fuse assembly in at least two spaced locations. For example, the hammer or other structural device may define a substantially U-shaped geometry, thereby bringing the hammer into closer proximity with the deflectable dome. The centerline of the U-shaped geometry of the hammer or other structure is generally aligned with the centerline of the deflectable dome, and thereby defines a preferred region of contact when the deflectable dome is actuated by a build up in pressure within the casing.

In exemplary embodiments, the deflectable dome is mounted internal to a plane defined by the casing (e.g., the base, side wall or top/lid of the casing) and the hammer or other structural member is mounted external to the plane defined by the casing. However, the hammer or other structural element defines a geometry, e.g., a U-shaped geometry, that extends across the planed defined by the casing and is thereby positioned at least in part internal to such plane. Although a U-shaped geometry for the hammer or other structural element is specifically contemplated, alternative geometries may also be employed, e.g., a parabolic geometry, a saw-tooth geometry with a substantially flattened contact region, or the like.

Turning to the vent structure that may be provided in exemplary embodiments of the present disclosure, the vent structure may be defined by a score line. A flame arrestor may be advantageously mounted with respect to the container/assembly so as to extend across an area defined by the vent structure internal to the container/assembly. In exemplary embodiments, the flame arrestor may take the form of a mesh structure, e.g., a 30 US mesh. In other exemplary embodiments, the flame arrestor may be fabricated from copper wire.

The vent structure of the present disclosure may be adapted to vent in response to a vent pressure of between about 10 psi and 140 psi. The structural limit pressure of the container (P4) may be at least about ten percent greater than the vent pressure.

The support member may include a kinetic energy absorbing material. The kinetic energy absorbing material may be formed of one of aluminum foam, ceramic, ceramic fiber, and plastic.

A plurality of cavity liners may be provided, each positioned between a corresponding one of the lithium ion core members and a surface of a corresponding one of the cavities. The cavity liners may define polymer and metal foil laminated pouches. A cavity liner may be positioned between each of the lithium ion core members and a surface of a corresponding one of the cavities. The cavity liners may be formed of a plastic or aluminum material. The plurality of cavity liners may be formed as part of a monolithic liner member.

An electrolyte is generally contained within each of the lithium ion core members. The electrolyte may include a flame retardant, a gas generating agent, and/or a redox shuttle.

Each lithium ion core member includes an anode, a cathode and separator disposed between each anode and cathode. An electrical connector is positioned within the container and electrically connects the core members to an electrical terminal external to the container. The fuse may be located at or adjacent to the electrical terminal external to the container.

The disclosed lithium ion battery components may be designed use in a variety of applications, e.g., in a battery electric vehicle (BEV), a plug-in hybrid electric vehicle (PHEV), a hybrid electric vehicle (HEV), electric trains, grid storage (GRID), construction, mining, and forestry equipment, forklifts, lead acid replacement (LAR), electronic bicycles (ebikes), portable equipment (e.g., medical equipment, yard, garden and landscaping tools/equipment, hand tools and the like) and other battery-supported devices and systems that typically use multiple lithium ion cells.

The support member may take the form of a honeycomb structure. The container may include a wall having a compressible element which when compressed due to a force impacting the wall creates an electrical short circuit of the lithium ion battery. The cavities defined in the support member and their corresponding core members may take be cylindrical, oblong, or prismatic in shape. The lithium ion battery according to any of the preceding claims, wherein the container includes a fire retardant member in the internal region.

The disclosed lithium ion battery may include a fire retardant member, e.g., a fire retardant mesh material affixed to the exterior of the container.

The disclosed lithium ion battery may include one or more endothermic materials, e.g., within a ceramic matrix. The endothermic material(s) may be an inorganic gas-generating endothermic material. The endothermic material(s) may be capable of providing thermal insulation properties at and above an upper normal operating temperature associated with the proximate one or more lithium ion core members. The endothermic material(s) may be selected to undergo one or more endothermic reactions between the upper normal operating temperature and a higher threshold temperature above which the lithium ion core member is liable to thermal runaway. The endothermic reaction associated with the endothermic material(s) may result in evolution of gas.

The endothermic material(s) may be included within a ceramic matrix, and the ceramic matrix may exhibit sufficient porosity to permit gas generated by an endothermic reaction associated with the endothermic material(s) to vent, thereby removing heat therefrom. See, e.g., US 2017/0214103 to Onnerud et al., the content of which was previously incorporated herein by reference. Alternative materials may be employed to provide protection against thermal runaway, e.g., FryeWrap® LiB performance materials (Unifrax I LLC, Tonawanda, N.Y.) and Outlast® LHS™ materials (Outlast Technologies LLC; Golden, Colo.).

The disclosed lithium ion battery may include a vent structure that is actuated at least in part based on an endothermic reaction associated with the endothermic material(s). The lithium ion battery may include a pressure disconnect device associated with the casing. The pressure disconnect device may advantageously include a deflectable dome-based activation mechanism. The deflectable dome-based activation mechanism may be configured and dimensioned to prevent burn through. Burn through may be prevented by (i) increasing the mass of the dome-based activation mechanism, (ii) adding material (e.g., foil) to the dome-based activation mechanism, or (iii) combinations thereof.

The increased mass of the dome-based activation mechanism and/or the material added to the dome-based activation mechanism may use the same type of material as is used to fabricate the dome-based activation mechanism. The increased mass of the dome-based activation mechanism and/or the material added to the dome-based activation mechanism may also use a different type of material (at least in part) as compared to the material used to fabricate the dome-based activation mechanism.

The design of the dome-based activation mechanism (e.g., material(s) of construction, geometry, and/or thickness/mass) may be effective in avoiding burn through at least in part based on the speed at which the dome-based activation mechanism will respond at a target trigger pressure.

In further exemplary embodiments of the present disclosure, a lithium ion battery is provided that includes (i) a container that defines a base, side walls and a top face; (ii) a deflectable dome structure associated with the container, and (iii) a fuse assembly including a fuse that is located at or adjacent to an electrical terminal externally positioned relative to the container. The fuse may be adapted, in response to a pressure build-up within the container beyond a threshold pressure level, to electrically isolate lithium ion battery components positioned within the container. The fuse may be positioned within a fuse holder. The disclosed lithium ion battery may also include a vent structure that is adapted to vent in response to a vent pressure of between about 10 psi and 140 psi.

Additional features, functions and benefits of the present disclosure will be apparent from the detailed description which follows, particularly when read in conjunction with the accompanying figures.

### BRIEF DESCRIPTION OF FIGURES

To assist those of skill in the art in making and using the disclosed assemblies, systems and methods, reference is made to the appended figures, wherein:

FIG. 1 is an exploded perspective view of an exemplary multi-core lithium ion battery with a first exemplary bus bar according to the present disclosure;

FIG. 2 is a top view of the exemplary multi-core lithium ion battery of FIG. 1 (with lid removed) according to the present disclosure;

FIG. 3 is a perspective view of the assembled exemplary multi-core lithium ion battery of FIGS. 1 and 2, according to the present disclosure;

FIG. 4 is an exploded perspective view of an alternative exemplary multi-core lithium ion battery with a second exemplary bus bar according to the present disclosure;

FIG. 5 is a top view of the alternative exemplary multi-core lithium ion battery of FIG. 4 (with lid removed) according to the present disclosure;

FIG. 6 is a perspective view of the assembled exemplary multi-core lithium ion battery of FIGS. 4 and 5, according to the present disclosure; and

FIG. 7 is a top perspective view of an exemplary electrochemical unit according to the present disclosure.

### DESCRIPTION OF EXEMPLARY EMBODIMENT(S)

In order to overcome the issues noted above and to realize safe and reliable prismatic cells across a range of sizes, including large prismatic cells, the present disclosure provides advantageous designs that provide, inter alia, manufacturing efficiencies and cost advantages. The designs disclosed herein may be used in combination and/or may be implemented in whole or in part to achieve desirable prismatic cell systems. As will be apparent to persons skilled in the art, the disclosed designs have wide ranging applicability and offer significant benefits in a host of applications, including lithium ion battery systems that are designed for use in battery electric vehicles (BEV), Plug-in Hybrid Electric Vehicles (PHEV), Hybrid Electric Vehicles (HEV), electric trains, grid storage (GRID), construction, mining and forestry equipment, forklifts, lead acid replacement (LAR), electronic bicycles (ebikes), portable equipment (e.g., medical equipment, yard, garden and landscaping tools/equipment, hand tools and the like) and other battery supported devices and systems that typically use multiple Li-ion cells. By way of example, in the general field of portable equipment, the disclosed designs may be employed in configurations that include serial electrochemical units (e.g., 10S systems) to deliver higher voltages, e.g., 48V, and that accommodate repeated start/stop operations. The bus bar assemblies disclosed herein permit selection of desired voltage/capacity parameters for a lithium ion battery without the need to redesign and/or reposition electrochemical units within the battery container or assembly.

Although the disclosed designs/systems are described largely in the context of a Li-ion cell using an array of individual jelly rolls, such as described in the patent filings incorporated herein by reference, it is to be understood by those skilled in the art that the disclosed designs and solutions may also be deployed in other prismatic and other cylindrical cell systems that package one or a plurality of cells (such as those made by AESC, LG) or that package standard prismatic cells having one or more non-separated flat wound or stacked electrode structures (such as those made by SDI, ATL and Panasonic). The disclosed designs/systems may also be used for encapsulating modules of sealed Li-ion cells.

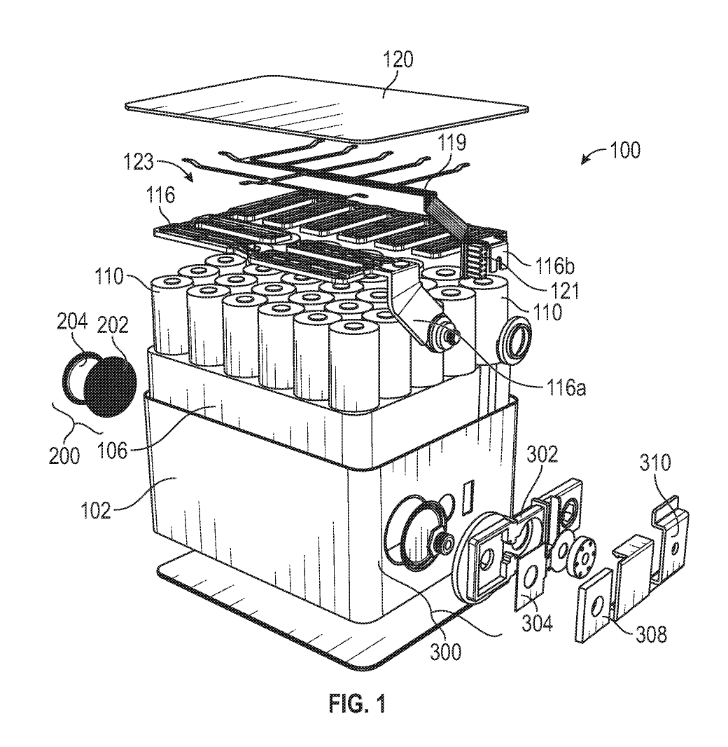

With reference to FIGS. 1-3, schematic illustrations of a first exemplary lithium ion battery implementation according to the present disclosure are provided. With initial reference to FIG. 1, an exploded view of an exemplary multi-core lithium ion battery 100 is provided.

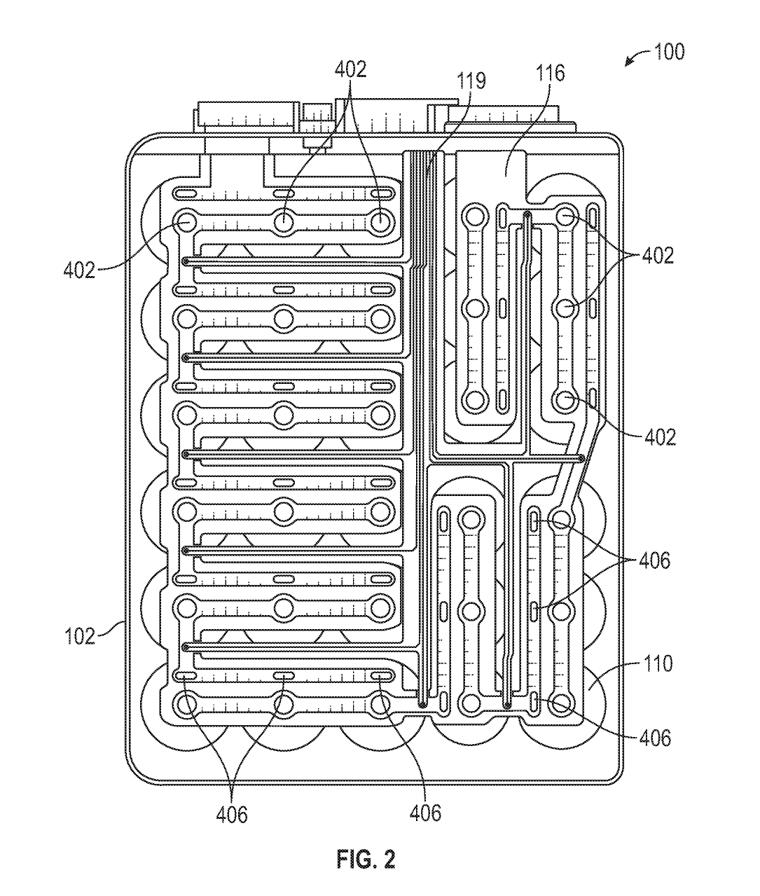

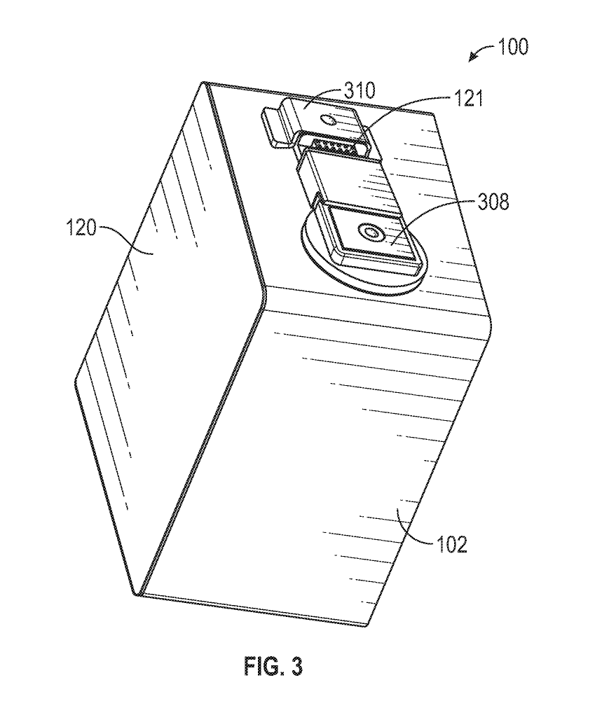

A top view (with lid removed) of lithium ion battery 100 is provided in FIG. 2 and an assembled view of the exemplary lithium ion battery is provided in FIG. 3.

Battery 100 includes an outer can or casing 102, that defines an interior region for receipt of components, as follows:
A housing or support structure 106 that defines a plurality (30) of spaced, substantially cylindrical regions or cavities that are configured and dimensioned to receive jelly roll/jelly roll sleeve subassemblies;
A plurality (30) jelly rolls 110, i.e., electrochemical units, configured and dimensioned to be positioned within the cylindrical regions defined in the support structure 106;
A substantially rectangular top cover 120 that is configured and dimensioned to cooperate with the outer can 102 to encase the foregoing components therewithin;
A one piece bus bar 116 that includes flange portions 116a, 116b that facilitate terminal contact;
A battery management system (BMS) 119 in electrical communication with bus bar 116 and external BMS connector 121;
A vent assembly 200 mounted with respect to the outer can 102; and
Anode terminal 308 and cathode terminal 310 externally mounted with respect to the outer can 102.

Of note, the jelly rolls 110 positioned within support 106 define a multi-core assembly that generally share headspace within outer can 102 and top cover 120, but do not communicate with each other side-to-side. Thus, any build-up in pressure and/or temperature associated with operation of any one or more of the jelly rolls 110 will be spread throughout the shared headspace and will be addressed, as necessary, by safety features associated with the disclosed battery system. However, electrolyte associated with a first jelly roll 110 generally does not communicate with an adjacent jelly roll 110 because the substantially cylindrical regions defined by housing 106 are generally designed to isolate jelly rolls 110 from each other from a side-to-side standpoint. Sleeves may be provided that surround the jelly rolls 110 and fit within the cavities of the support 106 may further contribute to the side-to-side electrolyte isolation as between adjacent jelly rolls 110.

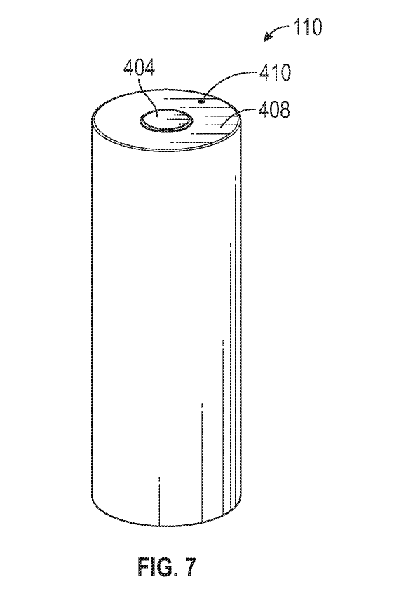

With particular focus on the bus bar assemblies of the present disclosure, it is noted that the anode and cathode portions of the disclosed bus bars are integrated into a single assembly. The anode and cathode portions are electrically isolated from each other by an intermediate insulative element. As shown in the top view of FIG. 2, exemplary bus bar 116 includes electrical connection/weld points for electrical connection to the anode and cathode of the individual electrochemical units. Thus, as schematically depicted in FIG. 2, substantially circular connection/weld points 402 are spaced along bus bar 116 to facilitate electrical connection to a centrally located electrical connection point/region defined on each electrochemical unit 110, e.g., nickel connection region 404 (see FIG. 7).

The bus bar 116 is advantageously designed such that the appropriate conductive portion, i.e., the anode or cathode portion of bus bar 116, is brought into electrical communication with the electrical connection region of the electrochemical unit 110. In the exemplary embodiment depicted herein, nickel connection region 404 corresponds to the cathode of the electrochemical unit 110 and is brought into electrical communication with the cathode portion of bus bar 116 (and is electrically isolated from the anode portion of bus bar 116) at the connection/weld points 402. The cathode portion of bus bar 116 may be advantageously fabricated from copper.

As also schematically depicted in FIG. 2, substantially elliptical connection/weld points 406 are spaced along bus bar 116 to facilitate electrical connection to a flange-like electrical connection region defined on each electrochemical unit 110, e.g., aluminum connection region 408 (see FIG. 7). In the exemplary embodiment depicted herein, aluminum flange region 408 corresponds to the anode of the electrochemical unit 110 and is brought into electrical communication with the anode portion of bus bar 116 (and is electrically isolated from the cathode portion of bus bar 116) at the elliptical weld regions 406. The anode portion of bus bar 116 may be advantageously fabricated from aluminum.

It is to be understood that the circular/elliptical geometries associated with the connection regions defined bus bar 116 are illustrative, and the present disclosure is not limited by or to such geometries. Rather, the connection regions for electrical connection of the bus bar 116 relative to the electrochemical units may take essentially any geometric shape—and may be identical for both the cathode and anode connections—as will be readily apparent to persons skilled in the art. Of significance, however, is the fact that the bus bar is fabricated such that electrical isolation exists between the cathode and anode portions, and that the integrity of the electrical connection relative to the cathode/anode portions of the electrochemical units is discretely maintained, i.e., the anode portion of the bus bar electrically communicates only with the anode of the electrochemical unit, and the cathode portion of the bus bar electrically communicates only with the cathode portion of the electrochemical unit.

As noted above, the conductive aspects of the bus bar may be fabricated from various conductive materials, e.g., metallic materials, conductive polymeric materials, and combinations thereof. The most common conductive bus bar materials are aluminum, copper and nickel. The conductive aspects of the disclosed bus bars may be advantageously fabricated from aluminum and copper due to the high electric conductivity and low cost associated with such metallic materials. The insulation material positioned between conductive layers is generally selected from known non-conductive/insulative materials, e.g., non-conductive polymers, ceramics and combinations thereof. Exemplary insulation materials include polyethylene, polypropylene and polytetrafluoroethylene (e.g., Teflon™ material).

The selection of a bus bar for a particular lithium ion battery implementation is generally guided by various parameters. For example, the capacity/voltage to be delivered by the lithium ion battery guides the manner in which individual electrochemical units are electrically connected relative to each other according to the present application. In addition, the selection of materials may be influenced by considerations of corrosion resistance, e.g., in view of the design of the electrochemical units, and conductivity/resistance parameters. Further, the bus bar design may be influenced by the overall size and capacity of the battery, e.g., to ensure that the bus bar is properly sized/dimensioned to offer reliable and safe operation for applicable current densities and the like.

Exemplary bus bar 116—as depicted in FIG. 2—supports and delivers a battery configuration that combines serial and parallel properties, specifically a 10S-3P configuration. Thus, when battery 100 is implemented with bus bar 116, the serially configured electrochemical units generate higher voltage, and the parallel aspect of the configuration contributes to greater capacity.

Of note, a BMS system 119 is provided to manage the electrical conditions within battery 100. According to the present disclosure, the BMS system 119 is advantageously positioned within the can or casing 102 and is located in the shared atmosphere region 123 defined “above” the electrochemical units, i.e., in a shared volume or region to which each of the electrochemical units is able to vent as/when appropriate based on internal conditions. The vent assembly 200 and the PDD assembly 300 also generally communicate with the shared atmosphere region 123 to facilitate safe operation of lithium ion battery 100. The BMS system 119 is in electrical communication with external BMS connector 121 that generally facilitates connection to a processor/processing system that may receive data reflecting conditions internal to lithium ion battery 100, provide control signals based on such data and control software operated by the processor/processing system, and generally manage operation of lithium ion battery 100 in view of the serial connectivity of the electrochemical units 110 positioned therewithin, as is known in the art.

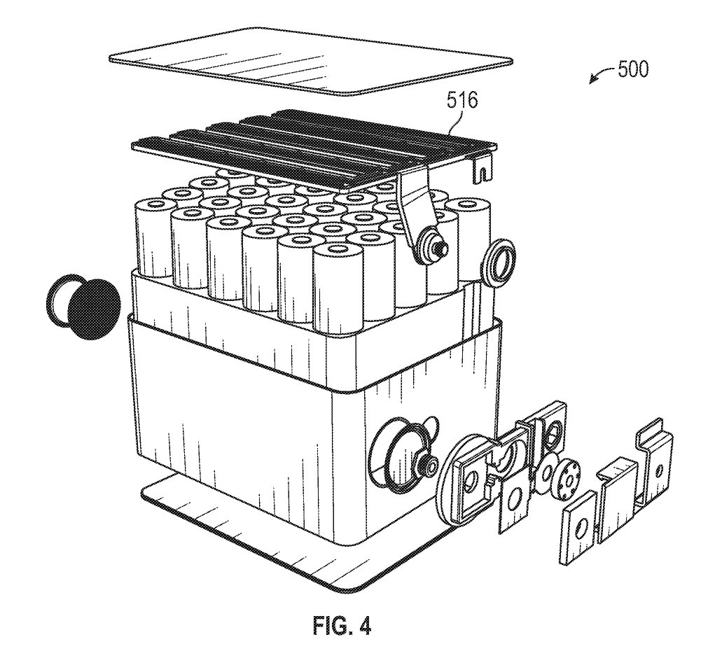

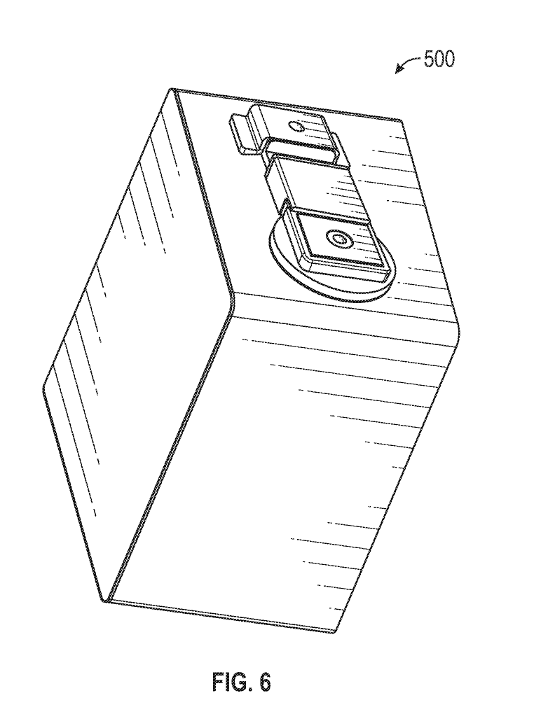

Turning to FIGS. 4-6, lithium ion battery 500 is identical to lithium ion battery 100 described herein above with reference to FIGS. 1-3 with two exceptions: (i) lithium ion battery 500 includes a bus bar 516 which features a different design as compared to bus bar 116, and (ii) lithium ion battery 500 does not include a BMS system. The absence of the BMS system is possible because the configuration of lithium ion battery corresponds to a 1S-30P configuration, and a BMS system is generally not required in such battery configurations.

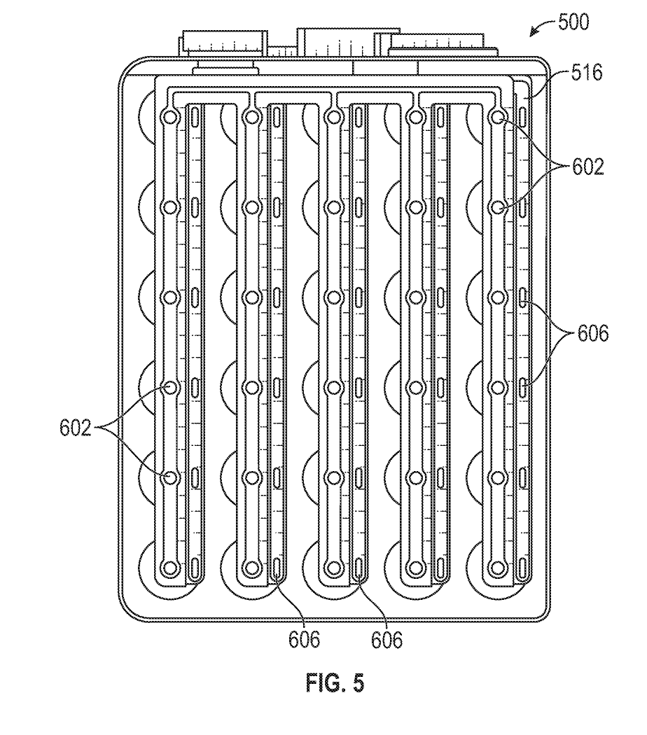

With further reference to FIG. 5, bus bar 516 includes electrical connection points for connection to the cathode and anode of the electrochemical units. As with the bus bar 116, substantially circular connection points 602 are spaced along bus bar 516 to facilitate electrical connection with the centrally located electrical connection points/regions defined on the electrochemical units 110, e.g., nickel connection region 404 (see FIG. 7), and elliptical connection/weld points 606 are spaced along bus bar 516 to facilitate electrical connection to flange-like electrical connection regions defined on each electrochemical unit 110, e.g., aluminum connection region 408 (see FIG. 7). As with bus bar 116, the bus bar 516 of FIG. 5 is a multi-layer laminated structure that includes a cathode portion and an anode portion. Thus, the electrical connections are discretely effectuated in the lithium ion battery 500 in like manner to the design of lithium ion battery 100. However, the manner in which the electrical connections are manifested in bus bar 516 fundamentally differs from the manifestation of bus bar 116, such that an entirely parallel configuration is achieved with bus bar 516 and lithium ion battery 100.

As is apparent from a comparison of FIGS. 1-3 with FIGS. 4-6, fundamentally different lithium ion batteries are achievable by the simple substitution of bus bar 116 with bus bar 516. Alternative bus bar configurations may also be designed/implemented that yield still further lithium ion battery variations, i.e., different serial/parallel configurations, without requiring a redesign or replacement of internal components of the battery (with the exception of possible inclusion/exclusion of a BMS system). By placing both anode and cathode connections on the same end of the electrochemical units (i.e., at the “top” from the perspective of FIGS. 1 and 4), a single bus bar may be used to make both anode/cathode connections, thereby further facilitating the interchangeability of the bus bars within an established lithium ion battery form factor.

According to exemplary implementations of the present disclosure, a plurality of bus bar designs that deliver distinct battery configurations/properties are designed, manufactured and inventoried. Thereafter, it is possible to manufacture lithium ion battery subassemblies that include, inter alia, the disclosed outer can, internal support and plurality of electrochemical units. The noted subassemblies will operate in conjunction with each of the bus bar designs, and based on selection of a desired bus bar from among the plurality of choices, a lithium ion battery that delivers a desired voltage/capacity may be produced.

With reference to FIG. 7, the electrochemical units 110 may include an aperture or hole 410 for use in introducing electrolyte to the electrochemical unit. The fill holes 410 may be positioned so as to permit electrolyte fill operations after positioning the bus bar thereabove, although exemplary embodiments contemplate electrolyte fill operations prior to positioning of the bus bar in electrical communication with the electrochemical unit. In exemplary embodiments, a vacuum is established within the electrochemical unit and electrolyte is drawn thru fill hole 410 at least in part based on the vacuum condition within the electrochemical unit. A plug may be applied to the fill hole 410 after introduction of the electrolyte, and such plug may be adapted to fail based on predetermined conditions within the electrochemical unit, e.g., a predetermined pressure, a predetermined temperature or a combination thereof. The plug may be fabricated from various materials, e.g., wax.

Although the exemplary electrochemical unit 110 of FIG. 7 generally depicts an electrochemical unit/jelly roll that is substantially sealed, it is to be understood that the present disclosure specifically contemplates lithium ion batteries that include electrochemical units/jelly rolls that are unsealed and open, such that when positioned within a can, each of the electrochemical units/jelly rolls is in communication with a shared atmosphere/region defined within the can. In this regard, reference is made to U.S. Pat. No. 9,685,644 entitled Lithium Ion Battery and its description of a “shared atmosphere” to which electrochemical units/jelly rolls are in communication. The '644 patent was previously incorporated herein by reference.

Exemplary safety features associated with the disclosed lithium ion battery are described herein with reference to lithium ion battery 100 of FIGS. 1-3 and include vent assembly 200 and pressure disconnect device (PDD) assembly 300. Corresponding safety features are also depicted and incorporated into the alternative lithium ion battery 500 of FIGS. 4-6, as will be readily apparent to persons skilled in the art. According to the exemplary battery 100, operative components of vent assembly 200 and PDD assembly 300 are mounted/positioned along walls of outer can 102. However, alternative positioning (in whole or in part) of one or both of vent assembly 200 and/or PDD assembly 300 may be effectuated without departing from the spirit/scope of the present disclosure, as will be apparent to persons skilled in the art based on the present disclosure. Additional features, functions and benefits of the disclosed vent assembly and PDD assembly (beyond those described herein below) are disclosed in PCT Publication No. WO 2017/106349 entitled “Low Profile Pressure Disconnect Device for Lithium Ion Batteries,” which was previously incorporated herein by reference.

The wall of outer can or casing 102 generally defines an opening. A flame arrestor 202 and a vent disc 204 are mounted across the opening. A seal is maintained in the region of flame arrestor 202 and vent disc 204, e.g., by a vent adapter ring. Various mounting mechanisms may be employed to fix the vent adapter ring to the wall, e.g., welding, adhesive, mechanical mounting structures, and the like (including combinations thereof). Of note, vent disc 204 is necessarily sealingly engaged relative to the wall and may be formed in situ, e.g., by score line(s) and/or reduced thickness relative to the top wall, as is known in the art.

In the event of a failure of an individual jelly roll (or multiple jelly rolls), a large amount of gas may be generated (˜10 liters), and this gas is both hot (˜250-300° C.) and flammable. It is likely that this gas will ignite outside of the multi-jelly roll enclosure after a vent occurs. To prevent the flame front from entering the casing, a mesh may be provided to function as flame arrestor 202 and may be advantageously placed or positioned over the vent area. This mesh functions to reduce the temperature of the exiting gas stream below its auto-ignition temperature. Since the mesh is serving as a heat exchanger, greater surface area and smaller openings reject more heat, but decreasing the open area of the mesh increases the forces on the mesh during a vent.

Turning to the electrical aspects of battery 100, an upstanding copper terminal is generally provided that functions as the anode for the disclosed lithium ion battery and is configured and dimensioned to extend upward thru an opening formed in a wall of outer can or casing 102. The upstanding terminal is in electric communication with a copper portion of bus bar 116 and flange portion 116a internal to casing 102. The upper end of the upstanding copper terminal is positioned within a fuse holder 302, which may define a substantially rectangular, non-conductive (e.g., polymeric) structure that is mounted along the wall of outer can/casing 102. The upstanding terminal is in electrical communication with a terminal contact face by way of fuse 304.

Fuse 304 is positioned within fuse holder 302 and external to outer can/casing 102 in electric communication with the upstanding copper terminal. A terminal screw may be provided to secure fuse 304 relative to fuse holder 302 and the upstanding terminal and the fuse components may be electrically isolated within the fuse holder 302 by a fuse cover.

A substantially U-shaped terminal 310 defines spaced flange surfaces that are in electrical and mounting contact with the wall of outer can/casing 102. An aluminum bus bar portion of bus bar 116 which is internal to casing 102 is in electrical communication with the outer can/casing 102, thereby establishing electrical communication with terminal 310. Terminal 310 may take various geometric forms, as will be readily apparent to persons skilled in the art. Terminal 310 is typically fabricated from aluminum and functions as the cathode for the disclosed lithium ion battery.

Thus, the anode terminal contact face 308 and cathode terminal 310 are positioned in a side-by-side relationship on the wall of casing 102 and are available for electrical connection, thereby allowing energy supply from battery 100 to desired application(s).

With reference to exemplary PDD assembly 300, a conductive dome is positioned with respect to a further opening defined in the wall of outer can/casing 102. The dome is initially flexed inward relative to the outer can/casing 102, and is thereby positioned to respond to an increase in pressure within the outer can by outward/upward deflection thereof. The dome may be mounted with respect to the wall by a dome adapter ring which is typically welded with respect to wall. In exemplary implementations and for ease of manufacture, a dome adapter ring may be pre-welded to the periphery of the dome, thereby facilitating the welding operation associated with mounting the dome relative to the wall due to the increased surface area provided by the dome adapter ring.

In use and in response to a build-up in pressure within the assembly defined by outer can/casing 102 and top cover 120, the dome will deflect upward relative to the wall of outer can/casing 102. Upon sufficient upward deflection, i.e., based on the internal pressure associated with battery 100 reaching a threshold level, a disconnect hammer is brought into contact with the underside of terminal contact face which is in electrical communication with fuse 304 within fuse holder 302. Contact between the disconnect hammer (which is conductive) completes a circuit and causes fuse 302 to “blow”, thereby breaking the circuit from the multi-core components positioned within the assembly defined by outer can 102 and top cover 120. Current is bypassed through the outer can 102. Of note, all operative components of PDD assembly 300—with the exception of the deflectable dome 312—are advantageously positioned external to the outer can 102 and top cover 120.

No intermediate or accessory structure is required to support the PPD and/or vent structures of the present disclosure. Indeed, only one additional opening relative to the interior of the battery is required according to the embodiments of the present disclosure, i.e., an opening to accommodate passage of the Cu terminal. The simplicity and manufacturing/assembly ease of the disclosed battery systems improves the manufacturability and cost parameters of the disclosed battery systems. Still further, the direct mounting of the PDD and vent assemblies relative to the can and/or lid of the disclosed batteries further enhances the low profile of the disclosed batteries. By low profile is meant the reduced volume or space required to accommodate the disclosed PDD and vent safety structures/systems, while delivering high capacity battery systems, e.g., 30 Ah and higher.

Exemplary Multi-Core Lithium Ion Battery Systems/Assemblies

In exemplary implementations of the present disclosure, a vent structure is defined in the lid of a multi-core lithium ion battery container. If a vent pressure is reached, a substantially instantaneous fracture of the vent structure along the score line takes place, thereby releasing pressure/gas from the vent opening—and through the 30 mesh flame arrestor—as the vent structure deflects relative to the metal flap, i.e., the unscored region of the vent structure.

Advantageous multi-core lithium ion battery structures according to the present disclosure offer reduced production costs and improved safety while providing the benefits of a larger size battery, such as ease of assembly of arrays of such batteries and an ability to tailor power to energy ratios. The advantageous systems disclosed herein have applicability in multi-core cell structures and a multi-cell battery modules. It is understood by those skilled in the art that the Li-ion structures described below can also in most cases be used for other electrochemical units using an active core, such as a jelly roll, and an electrolyte. Potential alternative implementations include ultracapacitors, such as those described in U.S. Pat. No. 8,233,267, and nickel metal hydride battery or a wound lead acid battery systems.

According to the present disclosure, exemplary multi-core lithium ion batteries are also described having a sealed enclosure with a support member disposed within the sealed enclosure. The support member includes a plurality of cavities and a plurality of lithium ion core members, disposed within a corresponding one of the plurality of cavities. There are a plurality of cavity liners, each positioned between a corresponding one of the lithium ion core members and a surface of a corresponding one of the cavities. The support member includes a kinetic energy absorbing material and the kinetic energy absorbing material is formed of one of aluminum foam, ceramic, and plastic. There are cavity liners formed of a plastic or aluminum material and the plurality of cavity liners are formed as part of a monolithic liner member. Instead of a plastic liner, also open aluminum cylindrical sleeves or can structures may be used to contain the core members. There is further included an electrolyte contained within each of the cores and the electrolyte includes at least one of a flame retardant, a gas generating agent, and a redox shuttle. Each lithium ion core member includes an anode, a cathode and separator disposed between each anode and cathode. There is further included an electrical connector within said enclosure electrically connecting the core members to an electrical terminal external to the sealed enclosure.

In another aspect of the disclosure, the core members are connected in parallel or they are connected in series. Alternatively, a first set of core members are connected in parallel and a second set of core members are connected in parallel, and the first set of core members is connected in series with the second set of core members. The support member is in the form of a honeycomb structure. The kinetic energy absorbing material includes compressible media. The enclosure includes a wall having a compressible element which, when compressed due to a force impacting the wall, creates an electrical short circuit of the lithium ion battery. The cavities in the support member and their corresponding core members are one of cylindrical, oblong, and prismatic in shape. The at least one of the cavities and its corresponding core member may have different shapes than the other cavities and their corresponding core members.

In another aspect of the disclosure, the at least one of the core members has high power characteristics and at least one of the core members has high energy characteristics. The anodes of the core members are formed of the same material and the cathodes of the core members are formed of the same material. Each separator member may include a ceramic coating and each anode and each cathode may include a ceramic coating. At least one of the core members includes one of an anode and cathode of a different thickness than the thickness of the anodes and cathodes of the other core members. At least one cathode includes at least two out of the Compound A through M group of materials. Each cathode includes a surface modifier. Each anode includes Li metal or one of carbon or graphite. Each anode includes Si. Each core member includes a rolled anode, cathode and separator structure or each core member includes a stacked anode, cathode and separator structure.

In another aspect of this disclosure, the core members have substantially the same electrical capacity. At least one of the core members has a different electrical capacity as compared to the other core members. At least one of the core members is optimized for power storage and at least one of the core members is optimized for energy storage.

In yet another aspect of the disclosure, there are include sensing wires electrically interconnected with the core members configured to enable electrical monitoring and balancing of the core members. The sealed enclosure includes a fire retardant member and the fire retardant member includes a fire retardant mesh material affixed to the exterior of the enclosure.

In another embodiment, there is described a multi-core lithium ion battery that includes a sealed enclosure. A support member is disposed within the sealed enclosure, the support member including a plurality of cavities, wherein the support member includes a kinetic energy absorbing material. There are a plurality of lithium ion core members disposed within a corresponding one of the plurality of cavities. There is further included a plurality of cavity liners, each positioned between a corresponding one of the lithium ion core members and a surface of a corresponding one of the cavities. The cavity liners are formed of a plastic or aluminum material (e.g., polymer and metal foil laminated pouches) and the plurality of cavity liners may be formed as part of a monolithic liner member. The kinetic energy absorbing material is formed of one of aluminum foam, ceramic, and plastic.

In another aspect of the disclosure, there is an electrolyte contained within each of the cores and the electrolyte includes at least one of a flame retardant, a gas generating agent, and a redox shuttle. Each lithium ion core member includes an anode, a cathode and separator disposed between each anode and cathode. There is further included an electrical connector within the enclosure electrically connecting the core members to an electrical terminal external to the sealed enclosure. The core members may be connected in parallel. The core members may be connected in series. A first set of core members may be connected in parallel and a second set of core members may be connected in parallel, and the first set of core members may be connected in series with the second set of core members.

In another aspect, the support member is in the form of a honeycomb structure. The kinetic energy absorbing material includes compressible media. The lithium enclosure includes a wall having a compressible element which, when compressed due to a force impacting the wall, creates an electrical short circuit of the lithium ion battery. The cavities in the support member and their corresponding core members are one of cylindrical, oblong, and prismatic in shape. At least one of the cavities and its corresponding core member may have different shapes as compared to the other cavities and their corresponding core members. At least one of the core members may have high power characteristics and at least one of the core members may have high energy characteristics. The anodes of the core members may be formed of the same material and the cathodes of the core members may be formed of the same material. Each separator member may include a ceramic coating. Each anode and each cathode may include a ceramic coating. At least one of the core members may include one of an anode and cathode of a different thickness as compared to the thickness of the anodes and cathodes of the other core members.

In yet another aspect, at least one cathode includes at least two out of the Compound A through M group of materials. Each cathode may include a surface modifier. Each anode includes Li metal, carbon, graphite or Si. Each core member may include a rolled anode, cathode and separator structure. Each core member may include a stacked anode, cathode and separator structure. The core members may have substantially the same electrical capacity. At least one of the core members may have a different electrical capacity as compared to the other core members. At least one of the core members may be optimized for power storage and at least one of the core members may be optimized for energy storage.

In another embodiment of the disclosure, sensing wires are electrically interconnected with the core members configured to enable electrical monitoring and balancing of the core members. The sealed enclosure may include a fire retardant member and the fire retardant member may include a fire retardant mesh material affixed to the exterior of the enclosure.

In another embodiment, a multi-core lithium ion battery is described which includes a sealed enclosure, with a lithium ion cell region and a shared atmosphere region in the interior of the enclosure. A support member is disposed within the lithium ion cell region of the sealed enclosure and the support member includes a plurality of cavities, each cavity having an end open to the shared atmosphere region. A plurality of lithium ion core members are provided, each having an anode and a cathode, disposed within a corresponding one of the plurality of cavities, wherein the anode and the cathode are exposed to the shared atmosphere region by way of the open end of the cavity and the anode and the cathode are substantially surrounded by the cavity along their lengths. The support member may include a kinetic energy absorbing material. The kinetic energy absorbing material is formed of one of aluminum foam, ceramic and plastic.

In another aspect, there are a plurality of cavity liners, each positioned between a corresponding one of the lithium ion core members and a surface of a corresponding one of the cavities. The cavity liners may be formed of a plastic or aluminum material. The pluralities of cavity liners may be formed as part of a monolithic liner member. An electrolyte is contained within each of the cores and the electrolyte may include at least one of a flame retardant, a gas generating agent, and a redox shuttle. Each lithium ion core member includes an anode, a cathode and separator disposed between each anode and cathode. There is an electrical connector within the enclosure electrically connecting the core members to an electrical terminal external to the sealed enclosure.

In yet another aspect, the core members are connected in parallel or the core members are connected in series. Alternatively, a first set of core members are connected in parallel and a second set of core members are connected in parallel, and the first set of core members is connected in series with the second set of core members.

In another embodiment, a lithium ion battery is described and includes a sealed enclosure and at least one lithium ion core member disposed within the sealed enclosure. The lithium ion core member include an anode and a cathode, wherein the cathode includes at least two compounds selected from the group of Compounds A through M. There may be only one lithium ion core member. The sealed enclosure may be a polymer bag or the sealed enclosure may be a metal canister. Each cathode may include at least two compounds selected from group of compounds B, C, D, E, F, G, L and M and may further include a surface modifier. Each cathode may include at least two compounds selected from group of Compounds B, D, F, G, and L. The battery may be charged to a voltage higher than 4.2V. Each anode may include one of carbon and graphite. Each anode may include Si.

In yet another embodiment, a lithium ion battery is described having a sealed enclosure and at least one lithium ion core member disposed within the sealed enclosure. The lithium ion core member includes an anode and a cathode. An electrical connector within the enclosure electrically connects the at least one core member to an electrical terminal external to the sealed enclosure; wherein the electrical connector includes a means/mechanism/structure for interrupting the flow of electrical current through the electrical connector when a predetermined current has been exceeded.

The present disclosure further provides lithium ion batteries that include, inter alia, materials that provide advantageous endothermic functionalities that contribute to the safety and/or stability of the batteries, e.g., by managing heat/temperature conditions and reducing the likelihood and/or magnitude of potential thermal runaway conditions. In exemplary implementations of the present disclosure, the endothermic materials/systems include a ceramic matrix that incorporates an inorganic gas-generating endothermic material. The disclosed endothermic materials/systems may be incorporated into the lithium battery in various ways and at various levels, as described in greater detail below.

In use, the disclosed endothermic materials/systems operate such that if the temperature rises above a predetermined level, e.g., a maximum level associated with normal operation, the endothermic materials/systems serve to provide one or more functions for the purposes of preventing and/or minimizing the potential for thermal runaway. For example, the disclosed endothermic materials/systems may advantageously provide one or more of the following functionalities: (i) thermal insulation (particularly at high temperatures); (ii) energy absorption; (iii) venting of gases produced, in whole or in part, from endothermic reaction(s) associated with the endothermic materials/systems, (iv) raising total pressure within the battery structure; (v) removal of absorbed heat from the battery system via venting of gases produced during the endothermic reaction(s) associated with the endothermic materials/systems, and/or (vi) dilution of toxic gases (if present) and their safe expulsion (in whole or in part) from the battery system. It is further noted that the vent gases associated with the endothermic reaction(s) dilute the electrolyte gases to provide an opportunity to postpone or eliminate the ignition point and/or flammability associated with the electrolyte gases.

The thermal insulating characteristics of the disclosed endothermic materials/systems are advantageous in their combination of properties at different stages of their application to lithium ion battery systems. In the as-made state, the endothermic materials/systems provide thermal insulation during small temperature rises or during the initial segments of a thermal event. At these relatively low temperatures, the insulation functionality serves to contain heat generation while allowing limited conduction to slowly diffuse the thermal energy to the whole of the thermal mass. At these low temperatures, the endothermic materials/systems materials are selected and/or designed not to undergo any endothermic gas-generating reactions. This provides a window to allow for temperature excursions without causing any permanent damage to the insulation and/or lithium ion battery as a whole. For lithium ion type storage devices, the general range associated as excursions or low-level rises are between 60° C. and 200° C. Through the selection of inorganic endothermic materials/systems that resist endothermic reaction in the noted temperature range, lithium ion batteries may be provided that initiate a second endothermic function at a desired elevated temperature. Thus, according to the present disclosure, it is generally desired that endothermic reaction(s) associated with the disclosed endothermic materials/systems are first initiated in temperature ranges of from 60° C. to significantly above 200° C. Exemplary endothermic materials/systems for use according to the present disclosure include, but are not limited to those set forth in Table 3 hereinbelow.

TABLE 3

| | | Approximate onset of |
|---|---|---|
| Mineral | Chemical Formula | Decomposition (° C.) |
| Nesquehonite | MgCO₃•3H₂O | 70-100 |
| Gypsum | CaSO₄•2H₂O | 60-130 |
| Magnesium phosphate | Mg₃(PO₄)₂•8H₂O | 140-150 |
| octahydrate | | |
| Aluminium hydroxide | Al(OH)₃ | 180-200 |
| Hydromagnesite | Mg₅(CO₃)₄(OH)₂•4H₂O | 220-240 |
| Dawsonite | NaAl(OH)₂CO₃ | 240-260 |
| Magnesium hydroxide | Mg(OH)₂ | 300-320 |
| Magnesium carbonate | MgO•CO_{2(0.96)}H₂O_{(0.3)} | 340-350 |
| subhydrate | | |
| Boehmite | AlO(OH) | 340-350 |
| Calcium hydroxide | Ca(OH)₂ | 430-450 |

These endothermic materials typically contain hydroxyl or hydrous components, possibly in combination with other carbonates or sulphates. Alternative materials include non-hydrous carbonates, sulphates and phosphates. A common example would be sodium bicarbonate which decomposes above 50° C. to give sodium carbonate, carbon dioxide and water. If a thermal event associated with a lithium ion battery does result in a temperature rise above the activation temperature for endothermic reaction(s) of the selected endothermic gas-generating material, then the disclosed endothermic materials/systems material will advantageously begin absorbing thermal energy and thereby provide both cooling as well as thermal insulation to the lithium ion battery system. The amount of energy absorption possible generally depends on the amount and type of endothermic gas-generating material incorporated into the formula, as well as the overall design/positioning of the endothermic materials/systems relative to the source of energy generation within the lithium ion battery. The exact amount of addition and type(s) of endothermic materials/systems for a given application are selected to work in concert with the insulating material such that the heat absorbed is sufficient to allow the insulating material to conduct the remaining entrapped heat to the whole of the thermal mass of the energy storage device/lithium ion battery. By distributing the heat to the whole thermal mass in a controlled manner, the temperature of the adjacent cells can be kept below the critical decomposition or ignition temperatures. However, if the heat flow through the insulating material is too large, i.e., energy conduction exceeds a threshold level, then adjacent cells will reach decomposition or ignition temperatures before the mass as a whole can dissipate the stored heat.

With these parameters in mind, the insulating materials associated with the present disclosure are designed and/or selected to be thermally stable against excessive shrinkage across the entire temperature range of a typical thermal event for lithium ion battery systems, which can reach temperatures in excess of 900° C. This insulation-related requirement is in contrast to many insulation materials that are based on low melting glass fibers, carbon fibers, or fillers which shrink extensively and even ignite at temperatures above 300° C. This insulation-related requirement also distinguishes the insulation functionality disclosed herein from intumescent materials, since the presently disclosed materials do not require design of device components to withstand expansion pressure. Thus, unlike other energy storage insulation systems using phase change materials, the endothermic materials/systems of the present disclosure are not organic and hence do not combust when exposed to oxygen at elevated temperatures. Moreover, the evolution of gas by the disclosed endothermic materials/systems, with its dual purpose of removing heat and diluting any toxic gases from the energy storage devices/lithium ion battery system, is particularly advantageous in controlling and/or avoiding thermal runaway conditions.

According to exemplary embodiments, the disclosed endothermic materials/systems desirably provide mechanical strength and stability to the energy storage device/lithium ion battery in which they are used. The disclosed endothermic materials/systems may have a high porosity, i.e., a porosity that allows the material to be slightly compressible. This can be of benefit during assembly because parts can be press fit together, resulting in a very tightly held package. This in turn provides vibrational and shock resistance desired for automotive, aerospace and industrial environments.

Of note, the mechanical properties of the disclosed endothermic materials/systems generally change if a thermal event occurs of sufficient magnitude that endothermic reaction(s) are initiated. For example, the evolution of gases associated with the endothermic reaction(s) may reduce the mechanical ability of the endothermic materials/systems to maintain the initial assembled pressure. However, energy storage devices/lithium ion batteries that experience thermal events of this magnitude will generally no longer be fit-for-service and, therefore, the change in mechanical properties can be accepted for most applications. According to exemplary implementations of the present disclosure, the evolution of gases associated with endothermic reaction(s) leaves behind a porous insulating matrix.

The gases produced by the disclosed endothermic gas-generating endothermic materials/systems include (but are not limited to) CO₂, H₂O and/or combinations thereof. The evolution of these gases provides for a series of subsequent and/or associated functions. First, the generation of gases between an upper normal operating temperature and a higher threshold temperature above which the energy storage device/lithium ion battery is liable to uncontrolled discharge/thermal runaway can advantageously function as a means of forcing a venting system for the energy storage device/lithium ion battery to open.

The generation of the gases may serve to partially dilute any toxic and/or corrosive vapors generated during a thermal event. Once the venting system activates, the released gases also serve to carry out heat energy as they exit out of the device through the venting system. The generation of gases by the disclosed endothermic materials/systems also helps to force any toxic gases out of the energy storage device/lithium ion battery through the venting system. In addition, by diluting any gases formed during thermal runaway, the potential for ignition of the gases is reduced.

The endothermic materials/systems may be incorporated and/or implemented as part of energy storage devices/lithium ion battery systems in various ways and at various levels. For example, the disclosed endothermic materials/systems may be incorporated through processes such as dry pressing, vacuum forming, infiltration and direct injection. Moreover, the disclosed endothermic materials/systems may be positioned in one or more locations within an energy storage device/lithium ion battery so as to provide the desired temperature/energy control functions.

A preferred mechanical seal for securing a lid relative to the can/container according to the present disclosure is a double seam. Double seaming is a means of connecting a top or bottom to a sidewall of a can by a particular pattern of edge folding. Double seamed joints can withstand significant internal pressure and intimately tie the top and sidewall together, but because of the extreme bends required in the joint the two flanges to be seamed together must be sufficiently thin—for aluminum sheet, double seamed joints are possible at thicknesses of less than 0.5 mm. If the operating pressure of the cell requires a thicker lid or can, provisions must be made to ensure that the seaming flanges of these thicker members must be reduced to 0.5 mm or less of thickness to make double seaming a possible method for sealing the can.

The overall design of the sealing mechanisms and its dependency on design parameters (overall dimensions, material thickness, and mechanical properties) for the container structure are highly interdependent as they affect the mechanical response to internal pressure especially and also external loads. This in turn also affects the venting and pressure disconnect structures. Certain sealing mechanisms, such as the low cost double seam, may only be used when venting pressure is low. Other sealing mechanisms, such as laser welding, are more robust, but still are dependent on limiting pressure when the container is not constrained. Material properties and dimensions are dependent on the methods chosen to effect the sealing of the closure. These interdependencies are complex and their relationships in the design space is not intuitive. The inventors have found that certain structures are particularly useful when optimizing functionality and cost of large Li-ion cells.

One major goal is to limit the overall growth of the container dimension when subjected to normal operating conditions of the cell. This growth amount is highly dependent on the length and width of the container, the thickness of the top and the joining method of the top closure to the container wall (See FIGS. 8 through 10 for examples of the thickness impact on displacements for a fixed container dimension). For a rectangular container the larger the plan view dimensions (length and width of the lid) the thicker the lid has to be in order to meet the deformation limit at operating pressure. From the governing equations (FIG. 7) for maximum deflection of a rectangular plate subject to a pressure load the deflection is a inverse cubic relation to the thickness for fixed boundary dimensions and further the deflection is a nominally a 5^{th} order function of the ling dimension of the plate. This drives one to grow the lid thickness very quickly as the container dimensions change. This is undesired as weight and volume is increased. Further the stresses at the boundary decrease as the inverse of the thickness squared which will have the benefit of reducing the stresses at the most critical region of the container the sealing joint. The displacements and stresses within the lid and/or walls can also be reduced by limiting the effective span of the wall or lid through the addition of supports, either in the form of tie members connecting the lid to the bas or opposite walls to one another. These tie points will effectively shorten the a or b dimensions in the equations in FIG. 1 and thus positively impact the displacement versus pressure profile of the container (see FIG. 11). These results play well with the concept of welding the lid to the container wall, but becomes a significant design challenge to mechanically joining the lid to the container. The mechanical joining processes require the container wall and/or lid remain below a certain thickness to allow for the required mechanical deformation that mechanically locks and seals the lid to the container.

The mechanical joints (double seam and crimp among others) can require the lid and container wall to be much thinner than required to resist the operating pressure of the cell. These restrictions can be mitigated through a number of mechanical processes to alter the thickness of the material local to the joints (e.g. coining, machining, ironing, etc.). Once the thickness is reduced to facilitate the joining the newly developed stresses at the joint must be analyzed and optimized. These same issues must be further addressed and considered in the overload case where pressures are allowed to go much higher than the operating pressure. As outlined elsewhere there are 4 pressure regimes that must be considered, the operating pressure limit is governed by the deformation limits of the container in its operating environment. For the container once the pressure exits the normal cell operating limit the events are to be considered anomalous and thus new requirements are imposed on the container. Once the container exits the operating pressure regime the limits for container expansion are relaxed but now the lid to container wall joint is required to contain the pressure beyond the value set in regime 4 where the container releases the internal pressure through a venting device built into the container. In the over pressure event the stresses in the joint become the governing design feature and the potential for strength change in the HAZ of a laser welded lid must be considered as well as the strength change due to thickness reduction required to make the joint with a mechanical method. These design trade-offs are complex and non obvious and require significant understanding of materials, manufacturing processes and joining methods and those interact with one another during the manufacturing of the containers.

In another example, at least a portion of the disclosed housing and/or cover may be fabricated from a thermally insulating mineral material (e.g., AFB® material, Cavityrock® material, ComfortBatt® material, and Fabrock™ material (Rockwool Group, Hedehusene, Denmark); Promafour® material, Microtherm® material (Promat Inc., Tisselt, Belgium); and/or calcium-magnesium-silicate wool products from Morgan Thermal Ceramics (Birkenhead, United Kingdom). The thermally insulating mineral material may be used as a composite and include fiber and/or powder matrices. The mineral matrix material may be selected from a group including alkaline earth silicate wool, basalt fiber, asbestos, volcanic glass fiber, fiberglass, cellular glass, and any combination thereof. The mineral material may include binding materials, although it is not required. The disclosed building material may be a polymeric material and may be selected from a group including nylon, polyvinyl chloride (“PVC”), polyvinyl alcohol (“PVA”), acrylic polymers, and any combination thereof. The mineral material may further include flame retardant additives, although it is not required, an example of such includes Alumina trihydrate (“ATH”). The mineral material may be produced in a variety of mediums, such as rolls, sheets, and boards and may be rigid or flexible. For example, the material may be a pressed and compact block/board or may be a plurality of interwoven fibers that are spongey and compressible. Mineral material may also be at least partially associated with the inner wall of the disclosed housing and/or cover, so as to provide an insulator internal of the housing and/or cover.

Although the present disclosure has been described with reference to exemplary implementations, the present disclosure is not limited by or to such exemplary implementations. Rather, various modifications, refinements and/or alternative implementations may be adopted without departing from the spirit or scope of the present disclosure.

1. A lithium ion battery, comprising:
a can that defines a base and side walls;
a lid mounted with respect to the can, such that the can and the lid define an internal volume;
a plurality of electrochemical units; and
a bus bar;
wherein the bus bar defines a multi-layer assembly that includes an anode portion, a cathode portion and an insulative intermediate layer; and
wherein the bus bar is effective to deliver a selected lithium ion battery configuration based on its electrical connection to the plurality of electrochemical units.

2. The lithium ion battery of claim 1, wherein the bus bar defines electrical connection points for electrical connection relative to the anode and the cathode of each electrochemical unit.

3. The lithium ion battery of claim 2, wherein the bus bar is configured to electrically isolate the anode connection from the cathode connection for each electrochemical unit.

4. The lithium ion battery of claim 1, wherein the bus bar is selected from a plurality of bus bar designs, each of the plurality of bus bar designs delivering a different voltage, a different capacity or a combination of a different voltage and a different capacity.

5. The lithium ion battery of claim 1, wherein the bus bar is effective to place certain of the electrochemical units in a parallel electrical configuration and certain of the electrochemical units in a serial configuration.

6. The lithium ion battery of claim 1, further comprising a battery management system.

7. The lithium ion battery of claim 1, further comprising a pressure disconnect device assembly.

8. The lithium ion battery of claim 1, further comprising a vent assembly.

9. The lithium ion battery of claim 8, wherein the vent assembly is mounted with respect to an opening formed in at least one of the can and the lid.

10. The lithium ion battery of claim 8, further comprising a flame arrestor mounted in proximity to the vent assembly.

11. The lithium ion battery of claim 10, wherein the flame arrestor is a mesh structure.

12. The lithium ion battery of claim 11, wherein the flame arrestor is a 30 US mesh.

13. The lithium ion battery of claim 10, wherein the flame arrestor is fabricated from copper wire.

14. The lithium ion battery of claim 1, wherein the electrochemical units are positioned in a support structure that defines cavities for receipt of individual electrochemical units.

15. The lithium ion battery of claim 14, wherein the electrochemical units are unsealed and in communication with a shared atmosphere region.

16. The lithium ion battery of claim 1, wherein the electrochemical units define an aperture for introduction of electrolyte.

17. The lithium ion battery of claim 16, further comprising a plug for introduction into the aperture after the electrolyte is delivered to the electrochemical unit.

18. The lithium ion battery of claim 1, wherein the anode portion and cathode portion of the multi-layer bus bar are fabricated from conductive materials.

19. The lithium ion battery of claim 18, wherein the conductive materials are selected from metallic materials, conductive polymeric materials, and combinations thereof.

20. The lithium ion battery of claim 1, wherein the conductive materials are selected from aluminum, copper and nickel.

21. The lithium ion battery of claim 18, wherein the insulative intermediate layer is fabricated from a non-conductive material selected from the group consisting of non-conductive polymers, ceramics and combinations thereof.

22. The lithium ion battery of claim 18, wherein the insulative intermediate layer is fabricated from an insulation material selected from polyethylene, polypropylene and polytetrafluoroethylene.

23. A lithium ion battery, comprising:
a can that defines a base and side walls;
a lid mounted with respect to the can, such that the can and the lid define an internal volume;
a plurality of electrochemical units; and
a bus bar;
wherein the bus bar defines a multi-layer assembly that includes an anode portion, a cathode portion and an insulative intermediate layer; and
wherein the bus bar serially connects the plurality of electrochemical units (in whole or in part).

24. A lithium ion battery, comprising:
a can that defines a base and side walls;
a lid mounted with respect to the can, such that the can and the lid define an internal volume;
a plurality of electrochemical units;
a bus bar providing serial electrical communication (at least in part) between the plurality of electrochemical units; and
a battery management system (BMS) positioned within the internal volume;
wherein the internal volume defines a shared atmosphere or region to which the plurality of electrochemical units is in communication;
wherein the battery management system (BMS) is positioned in the shared atmosphere or region.

25. The lithium ion battery of claim 24, wherein each of the electrochemical units is open or unsealed, such that the electrochemical unit is in direct communication with the shared atmosphere or region defined in the internal volume.

26. The lithium ion battery of claim 24, wherein the battery management system (BMS) is in electrical communication with an external BMS connector.

27. A multi-core lithium ion battery, comprising:
a support member including a plurality of cavities defined by cavity surfaces, wherein each of the plurality of cavities is configured to receive a lithium ion core member through a cavity opening;
a plurality of lithium ion core members, each of the plurality of lithium ion core members including an anode, a cathode, a separator positioned between the anode and the cathode, and electrolyte, and
a hermetically sealed enclosure that surrounds and encloses the support member;
wherein each of the plurality of lithium ion core members incudes an aperture that permits electrolyte introduction and is configured for receipt of plug after electrolyte introduction;
wherein each of the plurality of lithium ion core members is positioned in one of the plurality of cavities of the support member;
wherein each of the lithium ion core members is surrounded by a cavity surface of one of the plurality of cavities along its length such that electrolyte is prevented from escaping the cavity within which it is contained; and
wherein the hermetically sealed enclosure defines a shared atmosphere region to which (i) each of the cavities opens, and (ii) the anode, cathode and electrolyte of each ion core member are directly exposed through a cavity opening when positioned in a cavity of the support member.

28. The multi-core lithium ion battery of claim 27, wherein the plug is adapted to fail based on one or more predetermined conditions within the lithium ion core member.

29. The multi-core lithium ion battery of claim 28, wherein the one or more predetermined conditions is selected from the group consisting of a pressure condition, a temperature condition, or a combination of a pressure condition and a temperature condition.

30. The multi-core lithium ion battery of claim 27, wherein the plug is fabricated from wax.
